(19) United States
(12) Patent Application Publication
(10) Pub. No.: US 2017/0155275 A1
(43) Pub. Date: Jun. 1, 2017

(54) BACKUP CIRCUITRY FOR PROVIDING POWER

(71) Applicant: AirWire Technologies, Reno, NV (US)

(72) Inventors: Tuomas Kentala, Saskin (FI); Forrest Wolf, Reno, NV (US)

(21) Appl. No.: 14/954,727

(22) Filed: Nov. 30, 2015

(51) Int. Cl. H02J 9/06; H02J 7/00; H01H 85/04; H04B 1/3827

(52) U.S. Cl. CPC H02J 9/06; H04B 1/3827; H02J 7/0068; H01H 85/04; H02J 7/345

(57) ABSTRACT

A mobile device includes a plurality of capacitors in parallel to one another for storing electrical energy, and a switch configured to close an electrical connection between the plurality of capacitors and a portion of the mobile device for providing power to the portion of the mobile device, wherein the switch closes in response to the mobile device being in an operating mode and further in response to detecting absence of power being supplied by a power source. The mobile device may further include a power source, e.g., a battery. The mobile device may be a non-battery operated device. The plurality of capacitors is configured to be charged in response to the power source providing power to the mobile device. The plurality of capacitors is configured to provide power to the mobile device for at least 30 minutes in absence of power being supplied by the power source.

### BACKGROUND

Mobile devices such as laptops, cellular phones, iPads, etc., have become prevalent in recent years. Once the battery is depleted, the device shuts down and the data is lost. Therefore, it is important to recharge the battery before the device shuts down. Charging the battery may become a challenge during travel, commute, etc. Moreover, batteries occupy a large space that takes up valuable circuitry real estate and they further prevent devices from having smaller form factors. Batteries also require special handling throughout the supply chain that is complicated and costly.

### SUMMARY

Accordingly, a need has arisen to supply power to a mobile device when the battery is almost depleted. In some embodiments, the power may be supplied by means other than a battery or an external power source. As such, the amount of time that the mobile device can remain operational is extended. A need has further arisen to store electrical energy that can be used by the mobile device when it is not connected to an external power source or when the battery is almost depleted, where the storage of the electrical energy comes at a smaller cost to circuitry real estate of a mobile device than the battery. Moreover, a need has arisen to supply power through means other than a battery when the mobile device is not being charged by the external power source in order to eliminate the need to use a battery, e.g., lithium ion battery, and in order to reduce the size of the mobile device or to free up valuable circuitry real estate that can be used for other purposes, e.g., additional memory, a more powerful processor, larger display, etc. These and various other features and advantages will be apparent from a reading of the following detailed description.

According to some embodiments, a mobile device includes a first plurality of capacitors in parallel to one another for storing electrical energy, a second plurality of capacitors in parallel to one another for storing electrical energy, a first switch configured to close an electrical connection between the first plurality of capacitors and a first portion of the mobile device for providing power to the first portion of the mobile device to enable a first set of functionalities of the mobile device in absence of power being supplied by a power source, and a second switch configured to close a circuitry between the second plurality of capacitors and a second portion of the mobile device for providing power to the second portion of the mobile device to enable a second set of functionalities of the mobile device in absence of power being supplied by the power source.

In some embodiments, the amount of electrical energy stored by the first plurality of capacitors is different from amount of electrical energy stored by the second plurality of capacitors. According to one embodiment, the an amount of time that the first plurality of capacitors provide power to the first portion of the mobile device to enable the first set of functionalities is different from an amount of time that the second plurality of capacitors provide power to the second portion of the mobile device to enable the second set of functionalities.

It is appreciated that in some embodiments the first set of functionalities utilizes more electrical energy in comparison to the second set of functionalities. In one exemplary implementation, the first switch closes before the second switch, wherein the first switch closes in response to detecting absence of power being supplied by the power source, and wherein the second switch closes in response to detecting an amount of electrical energy stored in the first plurality of capacitors crossing a threshold and further in response to detecting absence of power being supplied by the power source. According to one embodiment, the mobile device is a non-battery operated device. The first and the second plurality of capacitors are configured to be charged in response to the power source providing power to the mobile device in accordance with some embodiments.

According to one embodiment, the first plurality of capacitors is configured to provide power to the mobile device for at least 30 minutes in absence of power being supplied by the power source. It is appreciated that according to some embodiments the mobile device may further include a voltage regulator configured to adjust a voltage output from the first plurality of capacitors to a desired operating voltage to enable the first set of functionalities of the mobile device. The mobile device may also include a protection circuitry configured to protect the first and the second plurality of capacitors and the first and the second portions of the mobile device from a power surge.

It is appreciated that in some embodiments, the first switch closes before the second switch, wherein the first switch closes in response to detecting absence of power being supplied by the power source and further in response to a user enabling the first set of functionalities of the mobile device. The second switch may close in response to detecting an amount of electrical energy stored in the first plurality of capacitors crossing a threshold and further in response to detecting absence of power being supplied by the power source.

According to one embodiment, the first switch closes when the second switch is open, and wherein the first set of functionalities utilizes more electrical energy in comparison to the second set of functionalities, and wherein the second switch closes in response to a user enabling the second set of functionalities and wherein the first switch opens subsequent to the second switch closing.

A mobile device may include a plurality of capacitors in parallel to one another for storing electrical energy, and a switch configured to close an electrical connection between the plurality of capacitors and a portion of the mobile device for providing power to the portion of the mobile device, wherein the switch closes in response to the mobile device being in an operating mode and further in response to detecting absence of power being supplied by a power source. The mobile device may further include the power source, wherein the power source is a battery. According to some embodiments, the mobile device is a non-battery operated device.

The plurality of capacitors is configured to be charged in response to the power source providing power to the mobile device. The plurality of capacitors is configured to provide power to the mobile device for at least 30 minutes in absence of power being supplied by the power source, according to some embodiments. The mobile device may include a voltage regulator configured to adjust a voltage output from the plurality of capacitors to a desired operating voltage of the mobile device. The mobile device may also include a protection circuitry configured to protect the plurality of capacitors and the portion of the mobile device from a power surge. The protection circuitry comprises a plurality of Schottky diodes, in some embodiments.

A mobile device in some embodiments may include a battery configured to supply power to the mobile device, a non-battery circuitry configured to store electrical energy, and a switch configured to close a electronic connection between the non-battery circuitry and a portion of the mobile device for providing power to the portion of the mobile device, wherein the switch closes in response to the mobile device being in an operating mode and further in response to detecting absence of power being supplied by an external power source and further in response to detecting an amount of electrical energy stored by the battery crossing a threshold, wherein the non-battery circuitry is configured to charge in response to the external power source providing power to the mobile device.

It is appreciated that according to some embodiments the functionalities associated with the portion of the mobile device are more limited in comparison to when the mobile device is fully functional. The non-battery circuitry may include a plurality of capacitors in parallel to one another. According to some embodiments, the non-battery circuitry has a smaller form factor than the battery. In one exemplary implementation, the non-battery circuitry is configured to provide power to the mobile device for at least 30 minutes in absence of power being supplied by the external power source and further in absence of power being supplied by the battery.

These and other features and aspects may be better understood with reference to the following drawings, description, and appended claims

### BRIEF DESCRIPTION OF DRAWINGS

The present invention is illustrated by way of example, and not by way of limitation, in the figures of the accompanying drawings and in which like reference numerals refer to similar elements.

FIG. 1 shows a mobile device with a non-battery electrical energy storage circuitry according to some embodiments.

FIG. 2 shows a mobile device with a non-battery electrical energy storage circuitry with a protection circuitry according to some embodiments.

FIG. 3 shows a protection circuitry in accordance with some embodiments.

FIG. 4 shows a non-battery electrical energy storage circuit in accordance with some embodiments.

FIG. 5 shows a controller in accordance with some embodiments.

FIG. 6 shows a mobile device with multiple non-battery electrical energy storage devices for providing power for various functionalities of the mobile device in accordance with some embodiments.

FIG. 7 shows another mobile device with multiple non-battery electrical energy storage devices for providing power for various functionalities of the mobile device in accordance with some embodiments.

FIG. 8 shows a battery-less mobile device in accordance with some embodiments.

FIG. 9 shows a battery-less mobile device with a protection circuitry in accordance with some embodiments.

FIG. 10 shows a battery-less mobile device with multiple non-battery electrical energy storage circuitries in accordance with some embodiments.

FIG. 11 shows another battery-less mobile device with multiple non-battery electrical energy storage circuitries in accordance with some embodiments.

### DETAILED DESCRIPTION

Reference will now be made in detail to various embodiments in accordance with the invention, examples of which are illustrated in the accompanying drawings. While the invention will be described in conjunction with various embodiments, it will be understood that these various embodiments are not intended to limit the invention. On the contrary, the invention is intended to cover alternatives, modifications, and equivalents, which may be included within the scope of the invention as construed according to the appended Claims. Furthermore, in the following detailed description of various embodiments in accordance with the invention, numerous specific details are set forth in order to provide a thorough understanding of the invention. However, it will be evident to one of ordinary skill in the art that the invention may be practiced without these specific details. In other instances, well known methods, procedures, components, and circuits have not been described in detail as not to unnecessarily obscure aspects of the invention.

Some portions of the detailed descriptions that follow are presented in terms of procedures, logic blocks, processing, and other symbolic representations of operations on data bits within a computer memory. These descriptions and representations are the means used by those skilled in the data processing arts and data communication arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical or magnetic signals capable of being stored, transferred, combined, compared, and otherwise manipulated in a computer system or computing device. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “identifying,” “creating,” “generating,” “storing,” “determining,” “sending,” “receiving,” “transmitting,” “communicating,” “providing,” “accessing,” “associating,” “disabling,” “enabling,” “configuring,” “initiating,” “starting,” “terminating,” “ending,” “maintaining,” “detecting,” “initializing,” “updating” or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

A need has arisen to supply power to a mobile device when the battery is almost depleted. In some embodiments, the power may be supplied by means other than a battery or an external power source. As such, the amount of time that the mobile device can remain operational is extended. A need has further arisen to store electrical energy in an electrical circuitry of a mobile device where the electrical circuitry for storing the electrical energy is different from a battery. In some embodiments, not only does the non-battery electrical energy storage circuitry power the mobile device but the non-battery electrical energy storage circuitry utilizes a smaller circuitry real estate of a mobile device than a traditional battery. Accordingly, the mobile device can remain operational for a longer period at minimal cost to circuitry real estate of the mobile device.

Moreover, a need has arisen to supply power through means other than a battery when the mobile device is not being charged by an external power source in order to eliminate the need to use a battery, e.g., lithium ion battery, to achieve a smaller form factor for the mobile device and/or to free up valuable circuitry real estate that can be used for other purposes, e.g., additional memory, a more powerful processor, larger display, etc. It is appreciated that a smaller form factor can be achieved by reducing the battery size because the battery can be complemented with the non-battery electrical storage circuit that is smaller in size. In some embodiments, a smaller form factor can be achieved by eliminating the battery all together and by replacing it completely with the non-battery electrical storage circuit.

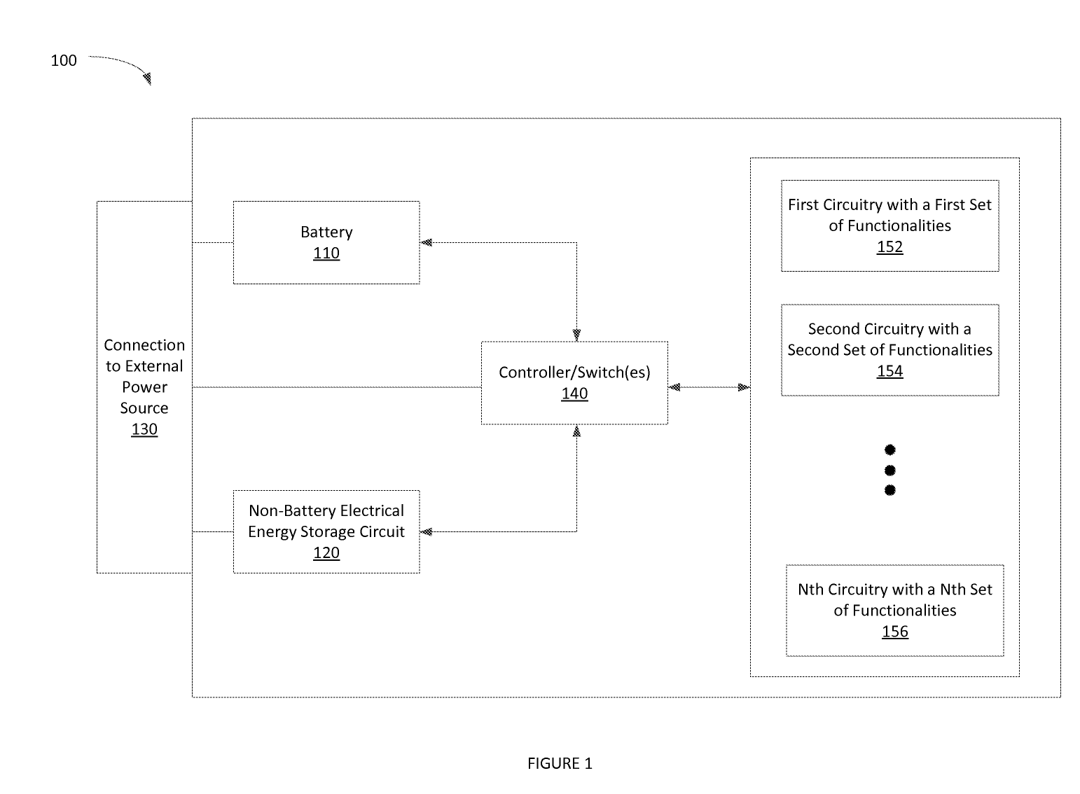

Referring now to FIG. 1, a mobile device with a non-battery electrical energy storage circuitry according to some embodiments is shown. The mobile device 100 includes a battery 110, a non-battery electrical storage circuit 120, a connection to external power source 130, a controller/switch(es) 140, and a plurality of circuitries 152-156. Each circuitry 152-156 may be associated with a particular functionality of the mobile device, e.g., display, LTE functionality, audio, touch sensors, etc.

According to some embodiments, the controller/switch(es) 140 may control various aspects and functionalities of the mobile device 100. For example, the controller/switch(es) 140 may control various applications being launched on the mobile device, may control the audio output, may control the input, may control the data transmission such as LTE, may control the battery 110, may control the non-battery electrical energy storage circuit 120, may control the memory component, may control the storage component such as solid state drive or the hard drive, etc. Circuitries controlling different operational functionality of the mobile device have been labeled as circuitries 152-156 as an example.

The connection 130 may provide a connection between the mobile device 100 and an external power source (not shown). The connection for example may be an AC power plug and socket, a DC connector, a blade connector, an IEC connector, a Molex connector, a Berg connector, an inductive connector, etc. When connected to an external power source, the battery 110 and/or the non-battery electrical energy storage circuit 120 may charge. In absence of a connection to the external power source, the battery 110 and/or the non-battery electrical energy storage circuit 120 may power the mobile device 100 in order to keep the mobile device 100 operational.

It is appreciated that powering the mobile device 100 through the battery 110 and/or the non-battery electrical energy storage circuit 120 may occur in any chronological order or in any combination thereof. For example, in absence of an external power supply, the battery 110 may power the mobile device 100 until its charge falls below a given threshold, e.g., 2% of its capacity, at which point the controller/switch(es) 140 may switch to the non-battery electrical energy storage circuit 120 to power the mobile device 100. In one embodiment, in absence of an external power supply, the non-battery electrical energy storage circuit 120 may power the mobile device 100 until its charge falls below a given threshold, e.g., 12% of its capacity, at which point the controller/switch(es) 140 may switch to the battery 110 to power the mobile device 100. In some embodiments, the controller/switch(es) may utilize both, the battery 110 and the non-battery electrical energy storage circuitry 120, simultaneously for power intensive applications. It is appreciated that the controller/switch(es) 140 may utilize any means for switching between various power supply means. In some embodiments, the controller/switch(es) 140 may utilize a multiplexer to control and switch between the battery 110 and the non-battery electrical energy storage circuit 120. In some embodiments, the controller/switch(es) 140 may utilize a transistor to switch between the battery 110 and the non-battery electrical energy storage circuit 120. For example, a bipolar transistor, an field effect transistor (FET) transistor or any combination thereof may be used by the controller/switch(es) 140 for switching between the battery 110 and the non-battery electrical energy storage circuit 120.

Accordingly, the mobile device 100 may remain operational even in absence of external power source. The length of time that the mobile device 100 remains operational is thus increased by adding the non-battery electrical energy storage circuit 120. The non-battery electrical energy storage circuit 120 has minimal impact on circuitry real estate of the mobile device because the non-battery electrical energy storage circuit 120 is much smaller in size in comparison to a battery, e.g., lithium battery, cellular phone battery, laptop battery, iPad battery, etc. Moreover, in some embodiments, the mobile device 100 can remain operational for at least 30 minutes or more (e.g. hours, days, months, etc.) when the non-battery electrical energy storage circuit 120 is the only source of power for the mobile device 100.

It is appreciated that each circuitry of the mobile device 100 that corresponds to a particular function may use a particular power, e.g., a first circuitry 152 with a first set of functionalities may use a first amount of power whereas a second circuitry with a second set of functionalities 154 may use a second amount of power. It is appreciated that circuitries 152-156 of the mobile device 100 may use the same or different amounts of power. The controller/switch(es) 140 may therefore control various circuitries 152-156 of the mobile device 100 in absence of the external power supply in order to extend the amount of time that the mobile device 100 can remain operational. For example, the controller/switch(es) 140 may shut down circuitries that are not being used in order to conserve energy, etc.

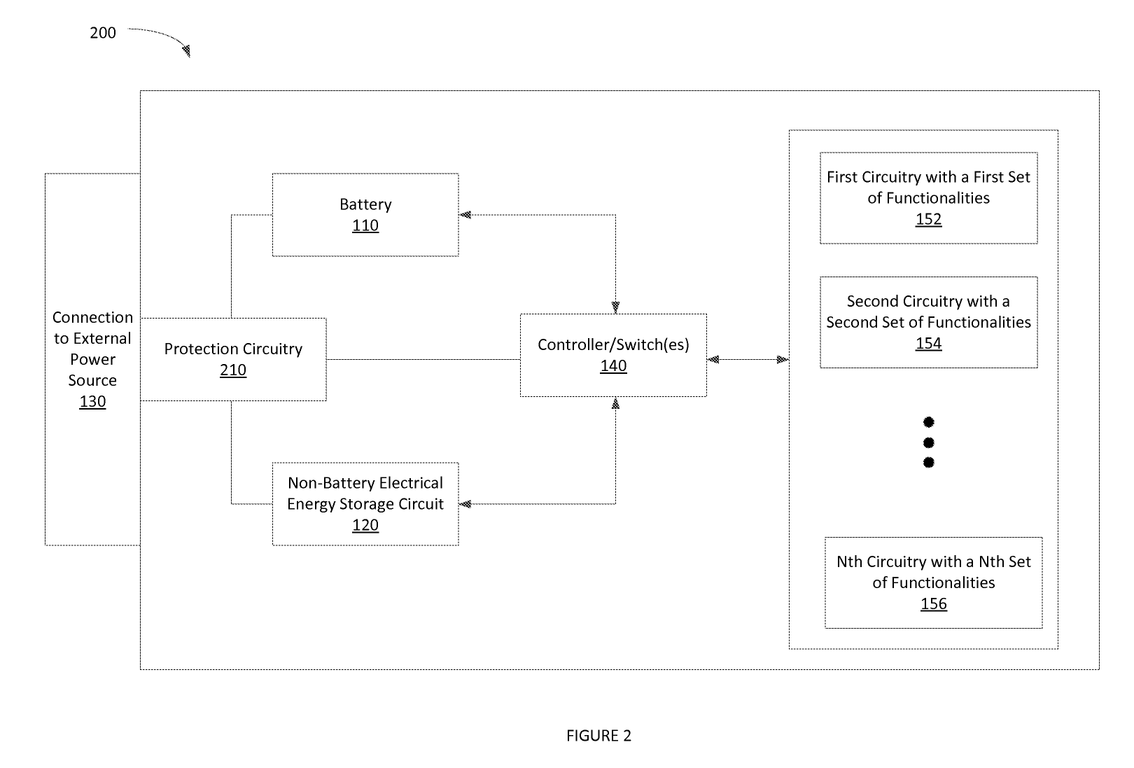

Referring now to FIG. 2, a mobile device 200 with a non-battery electrical energy storage circuitry with a protection circuitry according to some embodiments is shown. The mobile device 200 is similar to the mobile device 100 of FIG. 1 and operates in similar fashion. The mobile device 200 may further include a protection circuitry 210. The protection circuitry 210 may protect various circuitries of the mobile device 200 from undesirable and detrimental events, e.g., power surge, etc. For example, the protection circuitry 210 may protect the battery 110, the non-battery electrical energy storage circuit 120 and the controller/switch(es) 140 from a power surge. In some embodiments, the protection circuitry 210 may further protect other circuitries such as circuit 152-156 from a power surge (not shown).

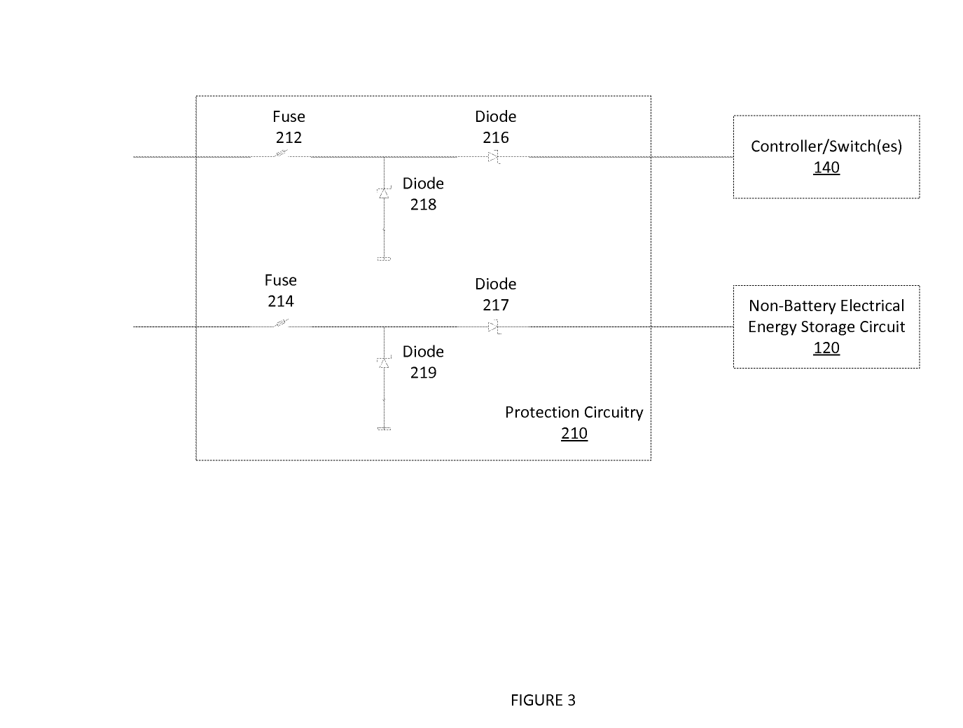

Referring now to FIG. 3, a protection circuitry in accordance with some embodiments is shown. The protection circuitry 210 may include a plurality of fuses 212-214 and a plurality of diodes 216-219. In this illustrative embodiment, the protection circuitry 210 protects the controller/switch(es) 140 and the non-battery electrical energy storage circuit 120. However, protection of only the controller/switch(es) 140 and the non-battery electrical energy storage circuit 120 is illustrative and should not be construed as limiting the scope of the embodiments. For example, the protection circuitry 210 may also protect other circuitries 152-156 (not shown).

In some embodiments, the fuses 212 and 214 protect the downstream circuitries from undesirable and detrimental events such as power surges. In this illustrative embodiment, the fuse 212 protects the controller/switch(es) 140 from a power surge while the fuse 214 protects the non-battery electrical energy storage circuit 120 from a power surge. A plurality of diodes, e.g., Schottky, may be used to reduce or eliminate current leakage. In this illustrative embodiment, diodes 218-219 are grounded and diodes 216 and 217 are in series with the fuses 212 and 214 respectively.

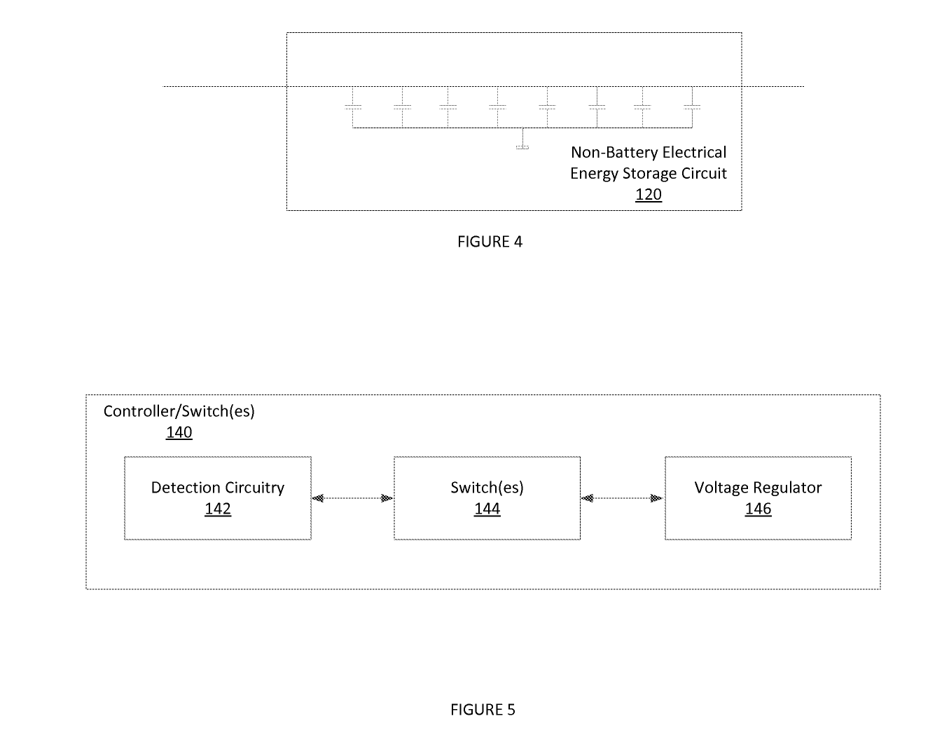

Referring now to FIG. 4, a non-battery electrical energy storage circuit in accordance with some embodiments is shown. The non-battery electrical energy storage circuit 120 may include a plurality of capacitors in parallel to one another. In this illustrative example, 8 capacitors are placed in parallel to one another. It is appreciated that the capacity of capacitors may be selected based on the amount of time that mobile device is to remain operational in absence of power from an external power source and/or a battery. For example, larger capacitors may be used to store more electrical power. Moreover, the number of capacitors used in parallel may vary depending on the application and the mobile device. As such, use of 8 capacitors in parallel to one another is for illustrative purposes and not intended to limit the scope of the embodiments. It is also appreciated that the capacitance increases when the capacitors are placed in parallel to one another. However, it is appreciated that other topology and configuration may also be used. For example, a ring topology, a star topology, etc., may also be used.

Referring now to FIG. 5, a controller in accordance with some embodiments is shown. The controller/switch(es) 140 may include a detection circuitry 142, switch(es) 144, a voltage regulator 146, or any combination thereof.

The detection circuitry 142 is configured to detect presence of absence of power from an external power source. Moreover, the detection circuitry 142 may be configured to detect various thresholds associated with the battery 110 and/or the non-battery electrical energy storage circuit 120. For example, the detection circuitry 142 may be configured to detect whether a certain threshold for the battery 110 has been reached, e.g., whether the charge of the battery 110 has reached 3%, whether the charge of the non-battery electrical energy storage circuit 120 has reached 5%, etc. It is appreciated that the detection circuitry 142 may be programmable, e.g., user programmable, to detect various thresholds, e.g., 3%, 5%, 1%, 12%, etc. As such, functionality of the detection circuitry 142 can be changed over time, as desired, to provide a greater flexibility.

Switch(es) 144 may include transistors, e.g., bipolar transistors, FET transistors, JFET transistor, MOSFET transistor, Darlington transistors, avalanche transistor, Schottky transistor, insulated-gate bipolar transistors, phototransistor, etc. Switch(es) 144 may be configured to switch between various sources of power, e.g., external, battery 110, non-battery electrical energy storage circuit 120, or any combination thereof, and further connect the source(s) of power to various portions of the mobile device circuitries 152-156. For example, switch(es) 144 may connect the non-battery electrical energy storage circuit 120 to circuitry 156 that powers the Nth set of functionalities of the mobile device 100. Moreover even though the embodiments have been described with respect to non-battery electrical energy storage circuit 120, it is appreciated that the switch(es) 144 may further control switching between a first plurality of capacitors in parallel to one another and a second plurality of capacitors in parallel to one another, etc., that may be part of the non-battery electrical energy storage circuit 120. For example, switch(es) 144 may switch a fourth plurality of capacitors of the non-battery electrical energy storage circuit 120 to a second circuitry 154 with a second set of functionalities. It is appreciated that the switch(es) 144 may be programmable to switch in any desired fashion. In some embodiments, the switch(es) 144 may be a field programmable gate array (FPGA) or any other controller that is programmable to switch and control the flow of power from a source to a desired circuitry of the mobile device.

The voltage regulator 146 may receive the provided voltage, e.g., from the switch(es) 144, and convert the received voltage to a desired voltage, e.g., by stepping the voltage up/down. For example, the voltage regulator 146 may step down the voltage received from the second plurality of capacitors in parallel to one another before providing that voltage to the second circuitry 154 with a second set of functionalities. In contrast, the voltage regulator 146 may step up the voltage received from the first plurality of capacitors in parallel to one another before providing that voltage to the first circuitry 125 with a first set of functionalities. Accordingly, each circuitry of the mobile device may receive the appropriate and desired operating voltage. It is appreciated that the voltage regulator 146 may include a bank of voltage regulators, each of which may be associated with a particular circuitry 152-156.

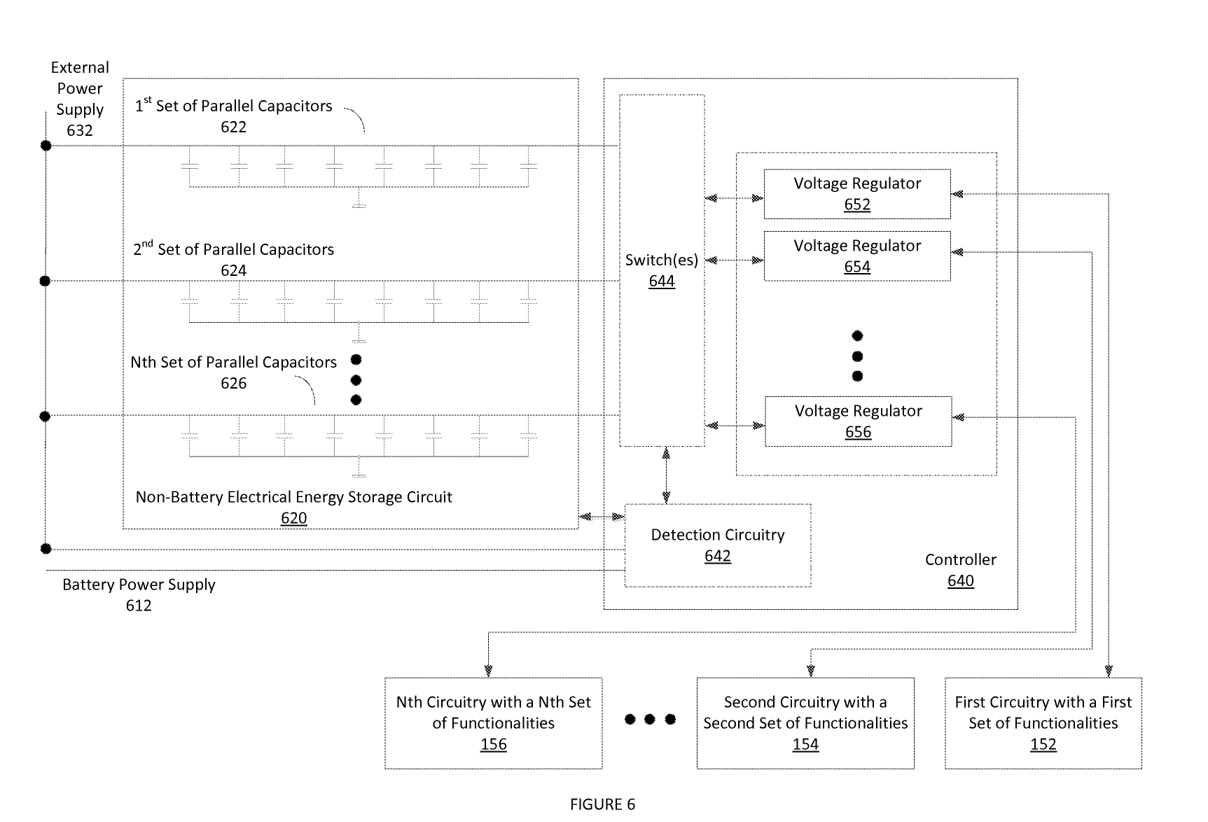

Referring now to FIG. 6, a mobile device with multiple non-battery electrical energy storage devices for providing power for various functionalities of the mobile device in accordance with some embodiments is shown. The mobile device includes a non-battery electrical energy storage circuit 620, a controller 640, and circuitries 152-156. The non-battery electrical energy storage circuit 620 operates in similar fashion to that described in FIGS. 1, 2 and 4. The controller 640 operates in similar fashion to that described in FIGS. 1-3, and 5. The circuitries 152-156 operate in similar fashion to those described in FIGS. 1 and 2.

The non-battery electrical energy storage circuit 620 may be charged when an external power supply 632 that provides power to the mobile device, e.g., through the connection 130. In absence of external power supply, the non-battery electrical energy storage circuit 620 may discharge and power one or more portions of the mobile device. The non-battery electrical energy storage circuit 620 includes a first set of parallel capacitors 622, a second set of parallel capacitors 624, and Nth set of parallel capacitors 626. It is appreciated that individual capacitors in each set may be of the same capacity or be different. For example, the capacitors within the first set of parallel capacitors 622 may be have the same capacitance or they may have different capacitance.

It is also appreciated that the capacitance for each set may the same or different, as desired. For example, the first set of parallel capacitors 622 may have a larger capacitance in comparison to the second set of parallel capacitors 624 which may have a larger capacitance in comparison to the Nth set of parallel capacitors 626. It is, however, appreciated that each set of parallel capacitors having a different capacitance is for illustrative purposes and should not be construed as limiting the scope of the embodiments.

According to some embodiments, each set of parallel capacitors may be associated with a particular circuitry of the mobile device controlling a particular functionality(ies). In other words, each set of parallel capacitors may power a particular circuitry of the mobile device. For example, the first set of parallel capacitors 622 may be associated with and power the first circuitry 152 with a first set of functionalities. The second set of parallel capacitors 624 may be associated with and power the second circuitry 154 with a second set of functionalities. The Nth set of parallel capacitors 626 may be associated with and power the Nth circuitry 156 with an Nth set of functionalities. It is appreciated that a set of parallel capacitors may power more than one circuitry of the mobile device. For example, the first set of parallel capacitors 622 may be associated with and power the first and the second circuitries 152-154.

The controller 640 includes a detection circuitry 642, switch(es) 644, and voltage regulators 652-656. The detection circuitry 642 may receive a signal from the battery (not shown), the external power supply, the non-battery electrical energy storage circuit 620, or any combination thereof. The detection circuitry 642 may determine whether power is being supplied through an external power source. In absence of external power supply, the detection circuitry 642 may detect a threshold charge associated with the battery and/or the non-battery electrical energy storage circuit 620. The switch(es) 644 may function similar to that described in FIGS. 1, 2, and 5 described above. In this embodiment, the switch(es) 644 switches between the battery and the non-battery electrical energy storage circuit 620 based on a determination by the detection circuitry 642, e.g., based on the threshold charge associated with the battery versus the non-battery electrical energy storage circuit. For example, the detection circuitry 642 may cause the switch(es) 644 to connect the non-battery electrical energy storage circuit 620 to power the mobile device if the charge of the battery is below a certain threshold, e.g., 1%. In other embodiments, the detection circuitry 642 may cause the switch(es) 644 to connect the non-battery electrical energy storage circuit 620 to power the mobile device before tapping into the battery which may occur when the charge associated with the non-battery electrical energy storage circuit 620 falls below a certain threshold, e.g., 7%. It is appreciated that the battery in conjunction with the non-battery electrical energy storage circuit 620 may be used for power intensive applications.

It is appreciated that the switch(es) 644 may switch a particular set of parallel capacitors, e.g., first set of parallel capacitors 622, to power a particular circuitry of the mobile device, e.g., first circuitry 152 with a first set of functionalities. It is appreciated that in order to provide the desired power, e.g., voltage, to the circuitry, a voltage regulator may be used. For example, the voltage regulator 652 may step up/down the input voltage from the first set of parallel capacitors 622 to a desired voltage for the corresponding circuitry, e.g., first circuitry 152 with a first set of functionalities. Similarly, voltage regulator 654 may be used to step up/down the input voltage from the second set of parallel capacitors 624 to a desired voltage for the corresponding circuitry 154 with a second set of functionalities. It is appreciated that a voltage regulator, e.g., voltage regulator 656, may provide a desired voltage and power more than one circuitry of the mobile device, e.g., circuitries 154-156.

Accordingly, one or more circuitries 152-156 of the mobile device may be powered by the battery, the non-battery electrical energy storage circuit 620, or any combination thereof and in any chronological order depending on the detected charge associated therewith. Thus, the amount of power usage of the mobile device may be controlled selectively, thereby extending the period of time the mobile device can remain operational. Moreover, the use of the non-battery electrical energy storage circuit 620 utilizes very minimal circuitry real estate while extending the period of time that the mobile device can remain operational by at least 30 minutes or more. In other words, a small form factor can be achieved while extending the amount of time that the mobile device can remain operational.

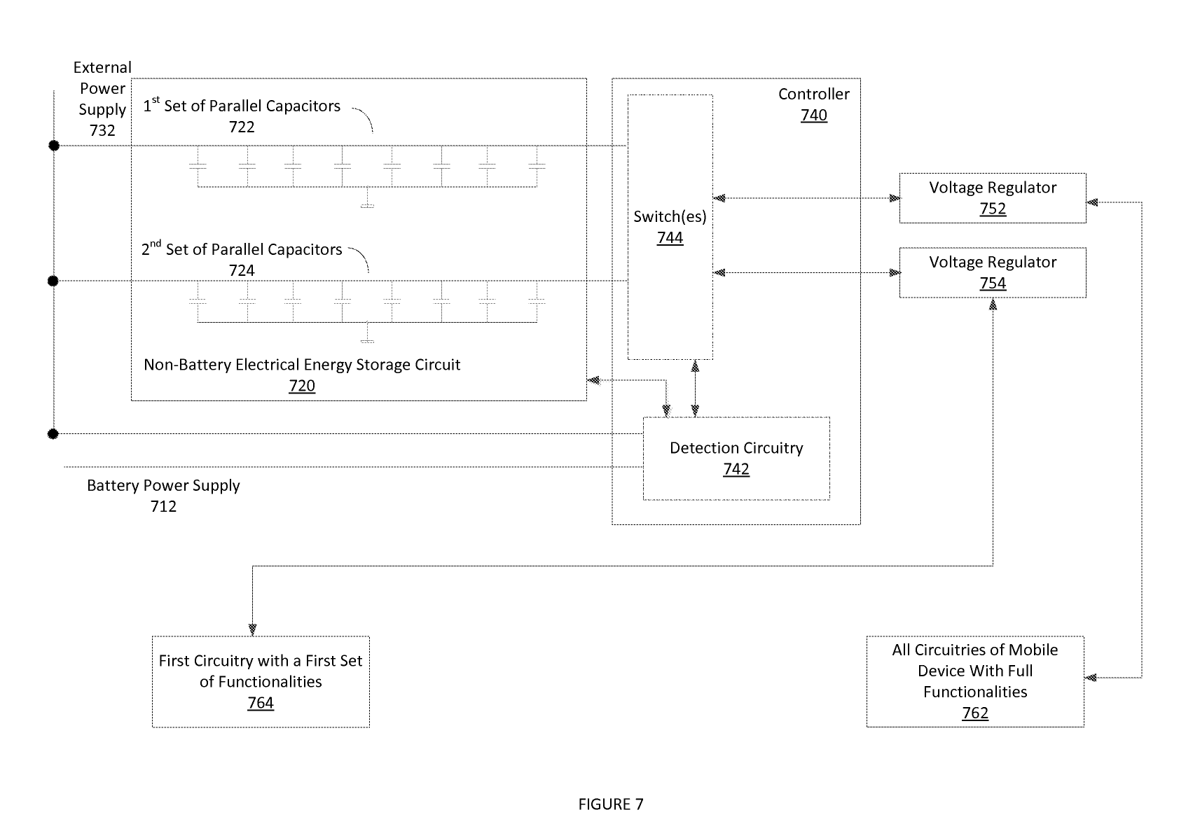

Referring now to FIG. 7, another mobile device with multiple non-battery electrical energy storage devices for providing power for various functionalities of the mobile device in accordance with some embodiments is shown. The mobile device of FIG. 7 is similar to that of FIG. 6. The first and the second set of parallel capacitors 722-724, the controller 740 including switch(es) 744 and a detection circuitry 742, and voltage regulators 752-754 are similar to those described in FIG. 6. However, in this embodiment, two sets of parallel capacitors are used and two voltage regulators 752-754 are used. In this embodiment, the first set of parallel capacitors 722 may be associated with and power all circuitries of the mobile device with full functionality 762 and the second set of parallel capacitors 724 may be associated with and power a first circuitry 764 with a first set of functionalities. It is appreciated that the first set of functionalities is less than full functionality, and may vary according to the remaining energy available. The voltage regulator 752 is associated with the first set of parallel capacitors 722 and steps up/down the input voltage to a desired voltage to power the entire mobile device whereas the voltage regulator 754 is associated with the second set of parallel capacitors 724 and steps up/down the input voltage to a desired voltage to power the first circuitry 764 with the first set of functionalities.

It is appreciated that FIGS. 6 and 7 may optionally include a protection circuitry (not shown). A protection circuitry may be used to protect circuitries within the mobile device, e.g., non-battery electrical energy storage circuit, circuitries associated with various functionalities of the mobile device, the controller, etc.

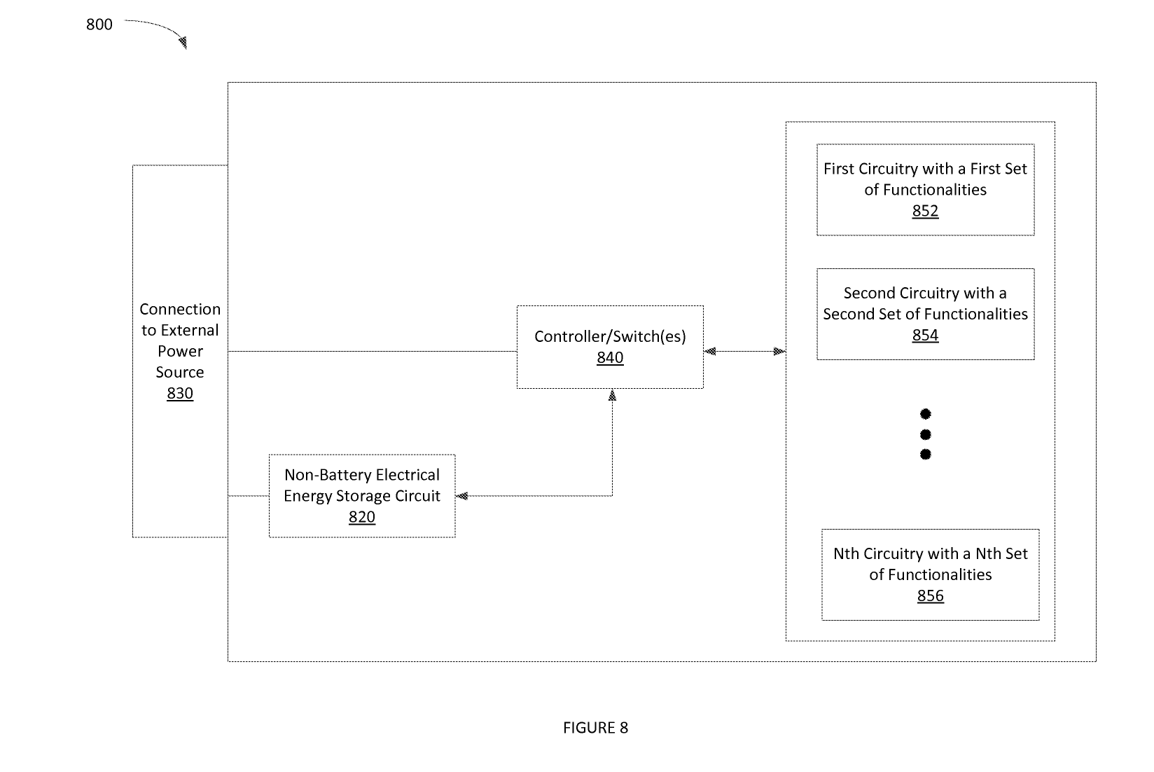

Referring now to FIG. 8, a battery-less mobile device in accordance with some embodiments is shown. The mobile device 800 is substantially similar to that of Figure mobile device 100. However, mobile device 800 is a battery-less mobile device. As such, in absence of an external power being supplied, power is being provided by the non-battery electrical energy storage circuit 820 exclusively. The mobile device 800 including connection 830, non-battery electrical energy storage circuit 820, controller/switch(es) 840, and circuitries 852-856 are similar to those described in earlier figures and operate in similar fashion.

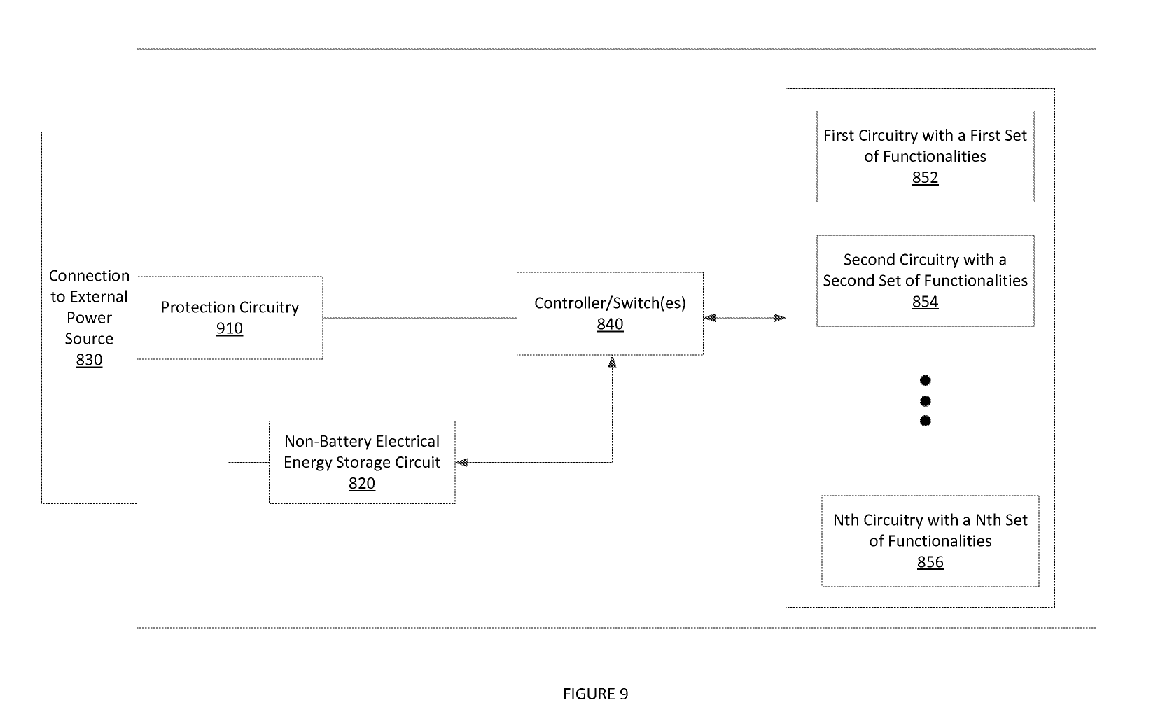

Referring now to FIG. 9, a battery-less mobile device with a protection circuitry in accordance with some embodiments is shown. The battery-less mobile device is similar to that of FIG. 8. However, the battery-less mobile device described herein includes a protection circuitry 910 to protect one or more circuitries of the mobile device, similar to that as described in FIGS. 2-3.

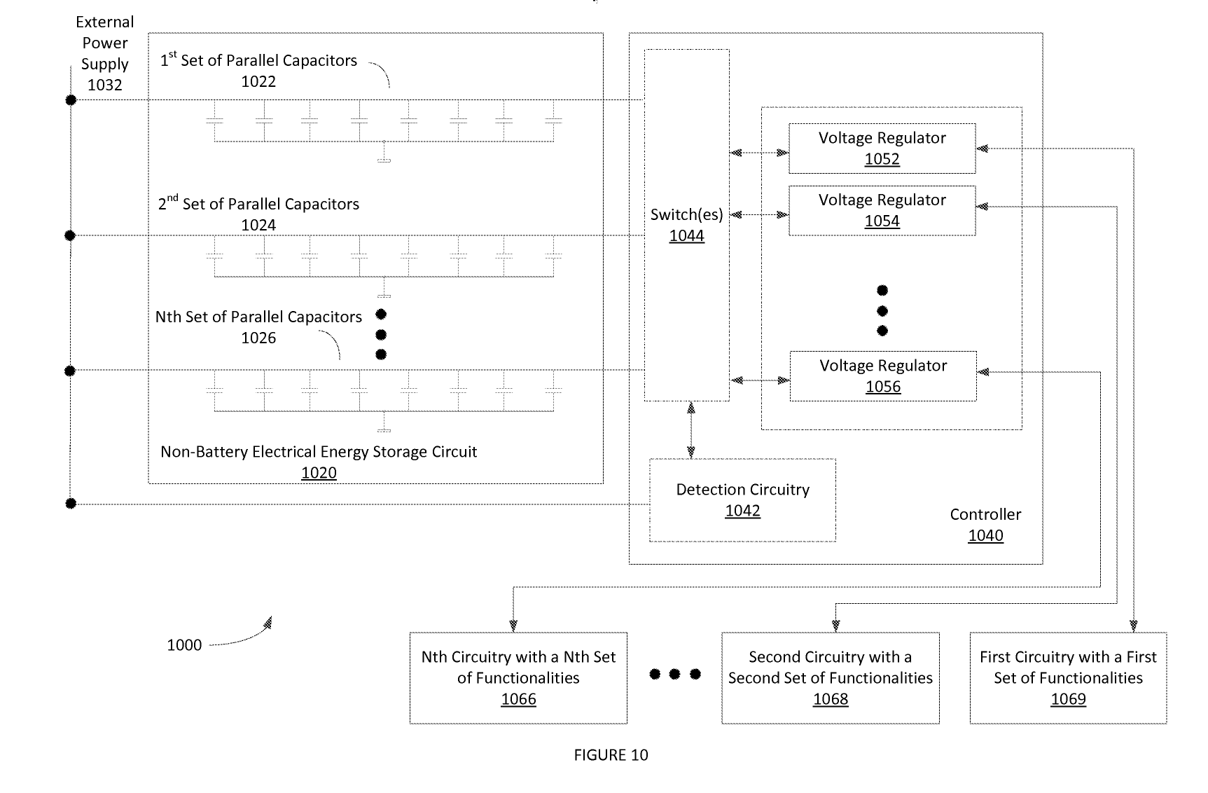

Referring now to FIG. 10, a battery-less mobile device 1000 with multiple non-battery electrical energy storage circuitries in accordance with some embodiments is shown. The battery-less mobile device 1000 is similar to that described in FIG. 6 except that in this embodiment, the mobile device does not include a battery. The mobile device 1000 includes a non-battery electrical energy storage circuit 1020 that includes a first, a second, and Nth set of parallel capacitors 1022-1026, a controller 1040 that includes a detection circuitry 1042, switch(es) 1044, and voltage regulators 1052-1056, and circuitries 1066-1069 that operate similar to those described in FIG. 6. The detection circuitry 1042 in this embodiment detects whether power is being provided through an external power source. In absence of power being provided through an external power source, the detection circuitry 1042 closes the switch(es) 1044 for the non-battery electrical energy storage circuit 1020 such that one or more circuitries 1066-1069 of the mobile device can be powered by the non-battery electrical energy storage circuit 1020. It is appreciated that detection circuitry 1042 and the switch(es) 1044 can connect any given set of parallel capacitors of the non-battery electrical energy storage circuit 1020 to one or more circuitries 1066-1069. It is appreciated that the output voltage from the set of parallel capacitors may be adjusted, e.g., step up/down, as needed using one or more voltage regulators 1052-1056 to provide the desired voltage to a given circuit of the mobile device with a particular functionality.

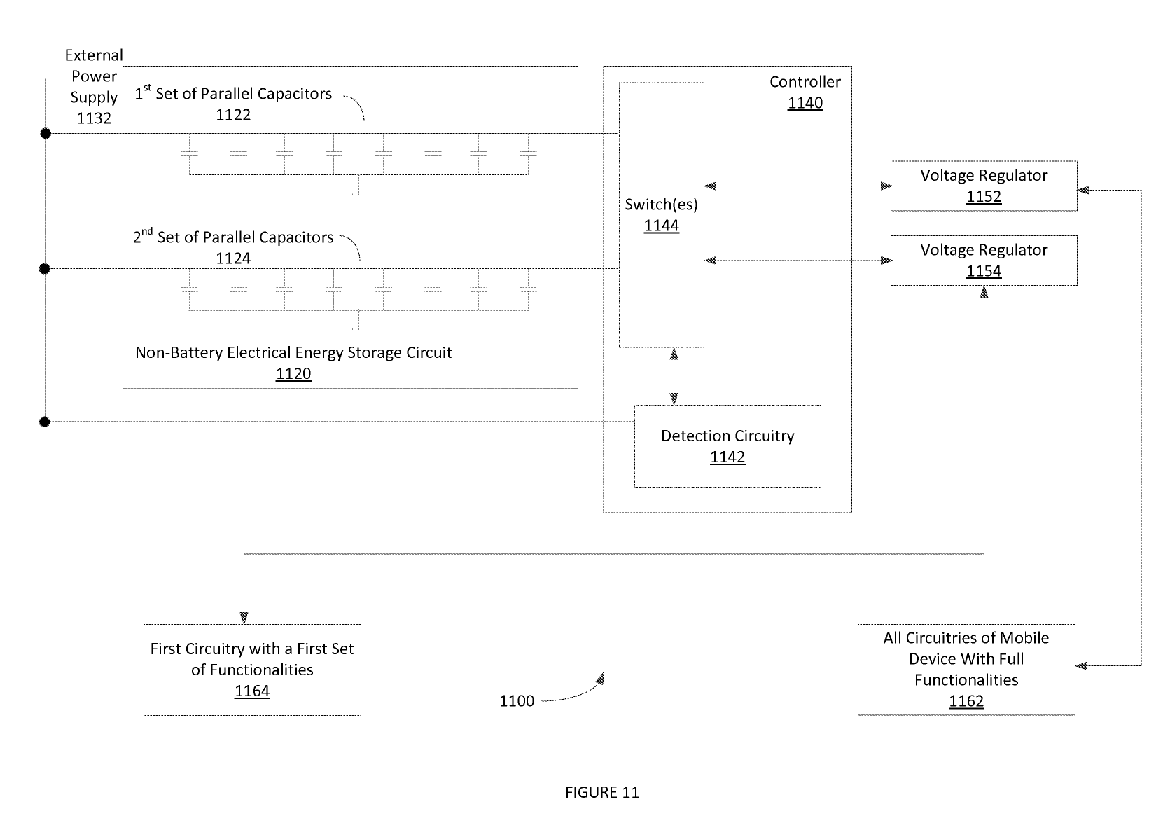

Referring now to FIG. 11, another battery-less mobile device 1100 with multiple non-battery electrical energy storage circuitries in accordance with some embodiments is shown. The battery-less mobile device 1100 is similar to that described in FIG. 7 except that in this embodiment, the mobile device does not include a battery. The mobile device 1100 includes a non-battery electrical energy storage circuit 1120 that includes a first and a second set of parallel capacitors 1122-1124, a controller 1140 that includes a detection circuitry 1142, switch(es) 1144, and voltage regulators 1152-1054, and circuitries 1162-1164 that operate similar to those described in FIG. 7. The detection circuitry 1142 in this embodiment detects whether power is being provided through an external power source. In absence of power being provided through an external power source, the detection circuitry 1142 closes the switch(es) 1144 for the non-battery electrical energy storage circuit 1120 such that one or more circuitries 1162-1164 of the mobile device can be powered by the non-battery electrical energy storage circuit 1120. It is appreciated that detection circuitry 1142 and the switch(es) 1144 can connect any given set of parallel capacitors of the non-battery electrical energy storage circuit 1120 to one or more circuitries 1162-1164. It is appreciated that the output voltage from the set of parallel capacitors may be adjusted, e.g., step up/down, as needed using one or more voltage regulators 1052-1054 to provide the desired voltage to a given circuit of the mobile device with a particular functionality.

Accordingly, one or more circuitries of the mobile device may be powered by the non-battery electrical energy storage circuit depending on the detected charge associated with each set of parallel capacitors. Thus, the amount of power usage of the mobile device may be controlled selectively, thereby extending the period of time the mobile device can remain operational. Moreover, the use of the non-battery electrical energy storage circuit instead of a battery utilizes very minimal circuitry real estate in comparison to a battery while powering the mobile device. Eliminating the battery and using a non-battery electrical energy storage circuit instead frees up valuable circuitry real estate to enable a smaller form factor for mobile device and/or to free up that space for additional functionalities, e.g., larger display, more powerful processor, more memory, etc. It is also appreciated that eliminating the battery may also reduce cost and complexity by avoiding the need to use special handling required during the supply chain process.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

What is claimed is:

1. A mobile device comprising:
a first plurality of capacitors in parallel to one another for storing electrical energy;
a second plurality of capacitors in parallel to one another for storing electrical energy;
a first switch configured to close an electrical connection between the first plurality of capacitors and a first portion of the mobile device for providing power to the first portion of the mobile device to enable a first set of functionalities of the mobile device in absence of power being supplied by a power source; and
a second switch configured to close a circuitry between the second plurality of capacitors and a second portion of the mobile device for providing power to the second portion of the mobile device to enable a second set of functionalities of the mobile device in absence of power being supplied by the power source.

2. The mobile device as described in claim 1, wherein an amount of electrical energy stored by the first plurality of capacitors is different from an amount of electrical energy stored by the second plurality of capacitors.

3. The mobile device as described in claim 1, wherein an amount of time that the first plurality of capacitors provides power to the first portion of the mobile device to enable the first set of functionalities is different from an amount of time that the second plurality of capacitors provides power to the second portion of the mobile device to enable the second set of functionalities.

4. The mobile device as described in claim 1, wherein the first set of functionalities utilizes more electrical energy in comparison to the second set of functionalities.

5. The mobile device as described in claim 1, wherein the first switch closes before the second switch, wherein the first switch closes in response to detecting absence of power being supplied by the power source, and wherein the second switch closes in response to detecting an amount of electrical energy stored in the first plurality of capacitors crossing a threshold and further in response to detecting absence of power being supplied by the power source.

6. The mobile device as described in claim 1, wherein the mobile device is a non-battery operated device.

7. The mobile device as described in claim 1, wherein the first and the second plurality of capacitors are configured to be charged in response to the power source providing power to the mobile device.

8. The mobile device as described in claim 1, wherein the first plurality of capacitors is configured to provide power to the mobile device for at least 30 minutes in absence of power being supplied by the power source.

9. The mobile device as described in claim 1 further comprising:
a voltage regulator configured to adjust a voltage output from the first plurality of capacitors to a desired operating voltage to enable the first set of functionalities of the mobile device.

10. The mobile device as described in claim 1 further comprising:
a protection circuitry configured to protect the first and the second plurality of capacitors and the first and the second portions of the mobile device from a power surge.

11. The mobile device as described in claim 1, wherein the first switch closes before the second switch, wherein the first switch closes in response to detecting absence of power being supplied by the power source and further in response to a user enabling the first set of functionalities of the mobile device.

12. The mobile device as described in claim 11, wherein the second switch closes in response to detecting an amount of electrical energy stored in the first plurality of capacitors crossing a threshold and further in response to detecting absence of power being supplied by the power source.

13. The mobile device as described in claim 1, wherein the first switch closes when the second switch is open, and wherein the first set of functionalities utilizes more electrical energy in comparison to the second set of functionalities, and wherein the second switch closes in response to a user enabling the second set of functionalities and wherein the first switch opens subsequent to the second switch closing.

14. A mobile device comprising:
a plurality of capacitors in parallel to one another for storing electrical energy; and
a switch configured to close an electrical connection between the plurality of capacitors and a portion of the mobile device for providing power to the portion of the mobile device, wherein the switch closes in response to the mobile device being in an operating mode and further in response to detecting absence of power being supplied by a power source.

15. The mobile device as described in claim 14 further comprising the power source, wherein the power source is a battery.

16. The mobile device as described in claim 14, wherein the mobile device is a non-battery operated device.

17. The mobile device as described in claim 14, wherein the plurality of capacitors is configured to be charged in response to the power source providing power to the mobile device.

18. The mobile device as described in claim 14, wherein the plurality of capacitors is configured to provide power to the mobile device for at least 30 minutes in absence of power being supplied by the power source.

19. The mobile device as described in claim 14 further comprising:
a voltage regulator configured to adjust a voltage output from the plurality of capacitors to a desired operating voltage of the mobile device.

20. The mobile device as described in claim 14 further comprising:
a protection circuitry configured to protect the plurality of capacitors and the portion of the mobile device from a power surge.

21. The mobile device as described in claim 20, wherein the protection circuitry comprises a fuse for protecting the plurality of capacitors and the portion of the mobile device from the power surge and wherein the protection circuitry further includes a plurality of Schottky diodes to reduce leakage current associated with the plurality of capacitors.

22. A mobile device comprising:
a battery configured to supply power to the mobile device;
a non-battery circuitry configured to store electrical energy; and
a switch configured to close a electronic connection between the non-battery circuitry and a portion of the mobile device for providing power to the portion of the mobile device, wherein the switch closes in response to the mobile device being in an operating mode and further in response to detecting absence of power being supplied by an external power source and further in response to detecting an amount of electrical energy stored by the battery crossing a threshold, wherein the non-battery circuitry is configured to charge in response to the external power source providing power to the mobile device.

23. The mobile device as described in claim 22, wherein functionalities associated with the portion of the mobile device are more limited in comparison to when the mobile device is fully functional.

24. The mobile device as described in claim 22, wherein the non-battery circuitry comprises a plurality of capacitors in parallel to one another.

25. The mobile device as described in claim 22, wherein the non-battery circuitry has a smaller form factor than the battery.

26. The mobile device as described in claim 22, wherein the non-battery circuitry is configured to provide power to the mobile device for at least 30 minutes in absence of power being supplied by the external power source and further in absence of power being supplied by the battery.
